(19) United States
(12) Patent Application Publication
(10) Pub. No.: US 2007/0237279 A1
(43) Pub. Date: Oct. 11, 2007

(54) System and method for fusion power generation using very high electrical potential difference

(76) Inventor: Sio-Hang Cheang, Cypress, CA (US)

Correspondence Address: SIO-HANG CHEANG, 8411 MARTINIQUE WAY, CYPRESS, CA, 90630, US

(21) Appl. No.: 11/397,394

(22) Filed: Apr. 5, 2006

(51) Int. Cl. H05H 1/22

(52) U.S. Cl. 376/100

(57) ABSTRACT

A fusion reactor system includes a reactor core containing a device capable of generating very high electrical potential difference on nuclear fusionable material. The reactor core produces very high electrical potential difference such that the high voltage circuit causes the fusionable material to generate a plasma in the form of artificial lightning. The electricity generated from the fusion reaction will then be conducted through a lightning conductor system. The lightning conductor system is not in the scope of this invention.

### BACKGROUND OF THE INVENTION

1. Field of Invention

With the ever-increasing need to be environmentally responsible and to conserve existing resources, intensive effort has been devoted to finding dean and renewable alternative energy sources. The present invention relates to the field of commercial electric energy production, and is intended to provide an environmentally benign means by which significant amounts of renewable and sustainable energy can be produced. More particularly, the present invention is directed to systems and method for the production of electrical power via nuclear fusion reactors utilizing very high electrical potential difference, causing artificial lightning on the fusionable material to fuse during the fusion burn. Benefits of the system include precise control and containment of the fusion burn while the cost of said fusion reaction can be produced at a very low cost comparing to the existing fusion designs.

2. Prior Art

To a large extent, efforts aimed at energy conservation and alternative energy generation have met with a large degree of success in such areas as the heating and cooling of structures, automobile efficiency and the like. Of which, fusion is attractive as an energy source because of the virtually inexhaustible supply of fuel, the promise of minimal adverse environmental impact, and its inherent safety.

Current scientific knowledge indicates that very little fusion occurs anywhere in nature. The reason is because in order to get two nuclei to fuse, it is necessary first to get them close together. However, because the two nuclei are both positively charged, they repel each other electrically. Nuclei will not fuse unless they collide with enough energy to overcome the electrical repulsion. The energy required for fusion is so high that fusion only occurs in appreciable amounts once the temperature gets over 10 million degrees Kelvin and very high atmospheric pressure—about 10 times of that on earth. In most conventional types of fusion, the fusion fuel must be heated to extremely high temperatures. At these temperatures, the fuel atoms collide so much and so hard that many electrons are knocked loose from their atoms. The result is a soup of ionized atoms and free electrons: plasma.

In order to achieve fusion, there are many designs on fusion reactors. Most of these designs rely on pulses of fusion burns. In fact, the fusion process does not continuously burn for extended periods of time. Also, plasma turbulence and resultant energy leakage has been long considered an unavoidable and intractable feature of plasmas. Scientists can now exercise a measure of control over such turbulence.

Electromagnetic waves can be injected and steered to manipulate the paths of plasma particles and then to produce the large electrical currents necessary to produce the magnetic fields to confine the plasma.

A number of reactor designs use toroidally shaped (donut-shaped) confinement arrangements for the reactor, or variations on a toroidally shaped reactor. A standard fusion reactor is described below:

Tokamak Fusion: The fusion reactor is designed to contain the fusion fuel plasma in a toroidally shaped electromagnetic containment field. The design has been able to contain plasmas for extended periods of time, reach very high temperatures and develop high densities.

Researchers have developed several methods for heating plasmas. These include Inertial Compression, Magnetic Compression, Neutral Beam Injection, Ohmic Heating, and Radio-Frequency Heating.

1. Inertial Compression

A gas can be heated by sudden compression. In the same way, the temperature of plasma is increased by decreasing the gas volume. In this inertial approach, the compression is achieved by using laser or particle beams to heat the outer layer of a target pellet. While the outer layer vaporizes, the vaporized layer exerts the pressure back on the core of the pellet and accelerates the plasma inward on itself. Then the inertia of the imploding atoms in the pellet allows the pellet to be compressed in a very short time. This causes the plasma to be heated.

2. Magnetic Compression

A gas can be heated by sudden compression. In this method, the temperature of plasma is increased when the gas volume is compressed rapidly by increasing the confining magnetic field. In a Tokamak system this compression is achieved simply by moving the plasma radically inward a region of higher magnetic field. Since plasma compression brings the ions closer together, the process has an additional benefit of facilitating attainment of the required density for a fusion reactor.

3. Neutral-Beam Injection

Neutral-beam injection involves the introduction of high-energy neutral atoms into the ohmically heated, and magnetically confined plasma. The atoms are immediately ionized and trapped by the magnetic field. Then the high-energy ions transfer part of their energy to the plasma particles in repeated collisions. This will rapidly increase the plasma temperature.

4. Ohmic Heating

The plasma is itself an electrical conductor. Therefore, it is possible to heat the plasma by passing a current through it whereas the current that generates the poloidal field also heats the plasma. This process is called ohmic, or resistive heating. It is similar to the heating process occurs in an electric light bulb or in an electric heater. In this process, the heat generated depends on the resistance of the plasma and the current. Experiment shows that as the temperature of heated plasma rises, the resistance decreases and the ohmic heating becomes less effective. As of now, It appears that the maximum plasma temperature attainable by ohmic heating in a Tokamak is somewhat between 20 to 30 million degrees Kelvin. Hence, additional heating methods have to be used to obtain still higher temperatures.

5. Radiofrequency Heating

In radiofrequency heating, high frequency waves are generated by oscillators outside the torus. If the waves have a particular frequency, their energy can be transferred to the charged particles in the plasma. Then the charged particles will collide with other plasma particles, thus increasing the temperature of the bulk plasma.

### SUMMARY

These prior fusion system and methods have largely failed to live up to its very promising expectations—a very important goal of nuclear fusion reactors is to create energy economically. This goal has not been achieved by the prior designs because they failed to produce any net energy. In fact, they require an input power almost equal to its output power, or greater input power is required than the output power. The system and method of the present invention shall overcome this deficiency with an energy gain of 100 percents or higher.

### SUMMARY OF THE INVENTION

Using either a Van De Graaff machine, or Tesla Coils, we can easily generate million-volt high voltage on the deuterium, tritium, or other fusionable gas mixture. The reaction produces natural lightning. Statistics show that natural lightning can produce millions kilowatts of power, and the power is not merely generated from the high potential difference. On the contrary, some natural lightning do not produce very high kilowatts of power. In fact, the theory of height between land and cloud does not explain the occasional high power generated from intra or inter clouds. Nor does it explain the great difference in peak current generated in various thunder storms. In other words, not all electrical power generated from each and every individual lightning could supply to the need of a large city. In fact, the peak current generated can be as low as 10 kA or even lower, and can go as high as 110 kA and higher. It is the presence of deuterium or other fusionable materials and very high electrical potential difference making the difference in power generated. It is fusion that occurs during a thunderstorm, which leads to the generation of high electrical power.

The present invention can be described as 2 independent basic systems and methods:
a. Van De Graaff machine in a dosed spherical space
b. Tesla Coils in a dosed spherical space

The heat generated from the fusion reaction could exceed 30,000 Kelvin degree of temperatures. The heat will radiate spherically. The design shall take into consideration of controlling the heat to avoid damaging the machines.

With the ever-increasing need to be environmentally responsible, more attention is being paid to dean, renewable energy sources. This invention is intended to provide an environmentally benign means by which significant amounts of renewable and sustainable energy can be produced. This invention includes:
1. The formation of a power plant, in closed space like a closed spherical dome.
2. The establishment of a system capable of generating very high electrical potential difference.
3. The said system will produce a discharge.
4. The said discharge will be directed to some fusionable materials.
5. A fusion reaction will be produced from the said system with fusionable materials and very high voltage discharge to produce further discharges.
6. A lightning conductor device to direct the said discharge to an electricity conductor.
7. Said fusionable materials are gas such as deuterium (an isotope of hydrogen having one proton and one neutron in its nucleus and having an atomic mass of 2) or tritium.
8. Said deuterium gas (or fusionable materials) will be electrically charged which could react to produce helium or tritium to release binding energy such that in each reaction, 17.6 MeV of energy (2.8 pJ) is liberated from the said deuterium gas
   D+T→⁴He (3.5 MeV)+n (14.1 MeV).
9. The charged particle will travel at very high speed due to the force applied charged particles in an electric field (E) experience a force in line with the electric field: F=q*E, where q is the charge of the particle and for positively charged ions (+) the force is in the direction of the electric field; for electrons (−) the force is in the opposite direction.
10. The average power of 10¹² watts of electric current provides said particle the needed force
11. Said movement will produce the possible outcome of fusing two deuterium nuclei (each having 1 proton, 1 neutron)—either tritium (T: 1 proton, 2 neutrons) or helium (2 protons, and either 1 neutron in He³ or 2 neutrons in He⁴).
12. Said nuclear reaction will continue for a period which releases energy-millions of electron volts (MeV) of energy per particle.
13. Said energy will be applied to repeat the cycle illustrated above, with excessive energy for commercial usage.

### CONCLUSION

Using simple devices of either a Van De Graaff machine, or Tesla Coils, million-volt high voltage can easily be generated on the deuterium and tritium gas mixture. Natural lightning produces millions kilowatts of power, and the power is not merely generated from the high potential difference. The theory of height between land and cloud does not explain the high power generated intra and inter clouds. Only Plasma physics offers better explanation.

The present invention generates electricity from fusion reaction with very high electrical potential difference.

The nuclear fusion of deuterium has been studied intensively for the past few decades. The reaction between two low energy deuterium nuclei has been observed to proceed in three ways:
a. D+D→He³ (0.82 MeV)+n (2.45 MeV)
b. D+D→T (1.01 MeV)+p (3.02 MeV)
c. D+D→He⁴+gamma (23.85 MeV)

The existing Fusion research requires high power input with negative or few gains. Cold Fusion cannot guarantee consistent result. Only the present invention induced by artificial lightning can produce satisfactory result.

Fusion is attractive as an energy source because of the virtually inexhaustible supply of fuel, the promise of minimal adverse environmental impact, and its inherent safety.
A Virtually Inexhaustible Fuel Supply. The basic fuels for fusion are deuterium and tritium. Both deuterium and lithium, from which tritium can be generated, are plentifully and inexpensively available.
Minimal Environmental Impact. Fusion does not yield greenhouse gases or other significant effluents that threaten environmental harm. Unlike some solar and wind technologies, fusion energy would make minimal demands on land use. And, although the intense neutrons from the fusion reaction will result in activation of reactor materials, the materials would not require isolation from the environment for extended periods of time.
Safety. The stored energy of the fusion fuel contained in the reactor would likely be equivalent to only a few minutes of power production in the case of magnetic fusion energy and fractions of a second in the case of inertial fusion energy. Accidents thus do not threaten wide-ranging impact.

Whether a fusion reaction producing sufficient net energy gain to be attractive as a commercial power source can be sustained and controlled—can and will be solved.

### BRIEF DESCRIPTION OF THE DRAWINGS

FIG. 1—is a schematic drawing of the Van De Graaff machine process;

FIG. 2—is a schematic drawing of the Tesla Coils process;

FIG. 3—is a schematic drawing of the fusion reactor with energy generated from Van De Graaff machines with Magnet System in closed space;

FIG. 4—is a schematic drawing of the fusion reactor with energy generated from Van De Graaff machines in a very large closed space;

FIG. 5—is a schematic drawing of the Balloon Stuffing Machine

FIG. 6—is a schematic drawing of the Balloon Ejector

### DESCRIPTION OF THE SPECIFIC EMBODIMENT

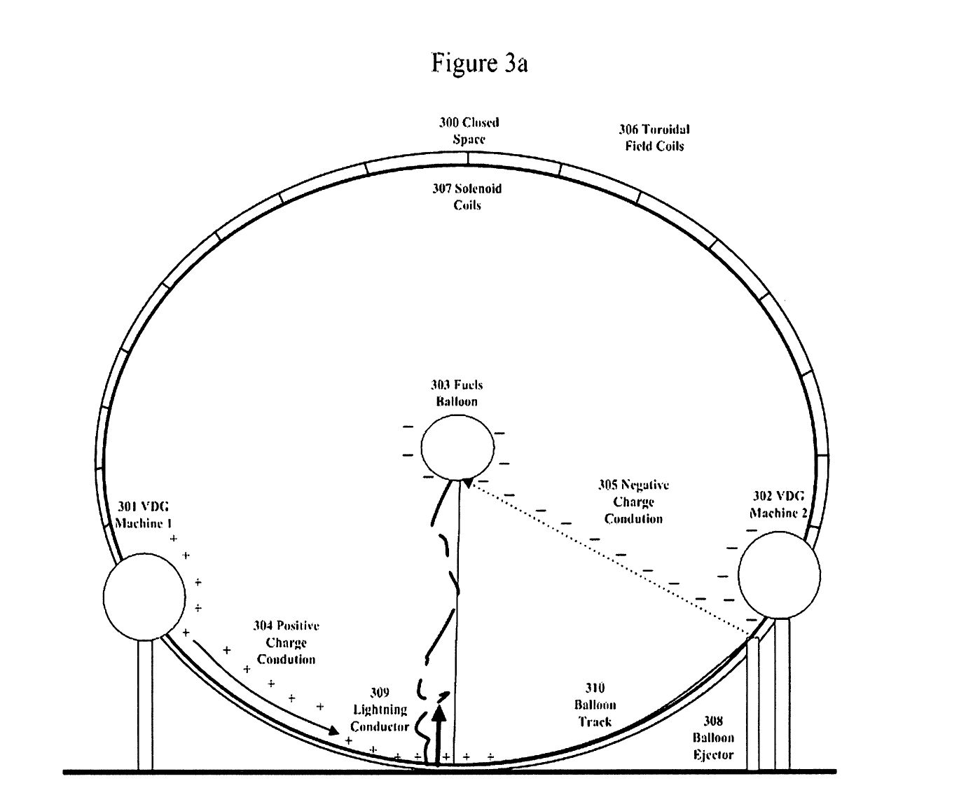

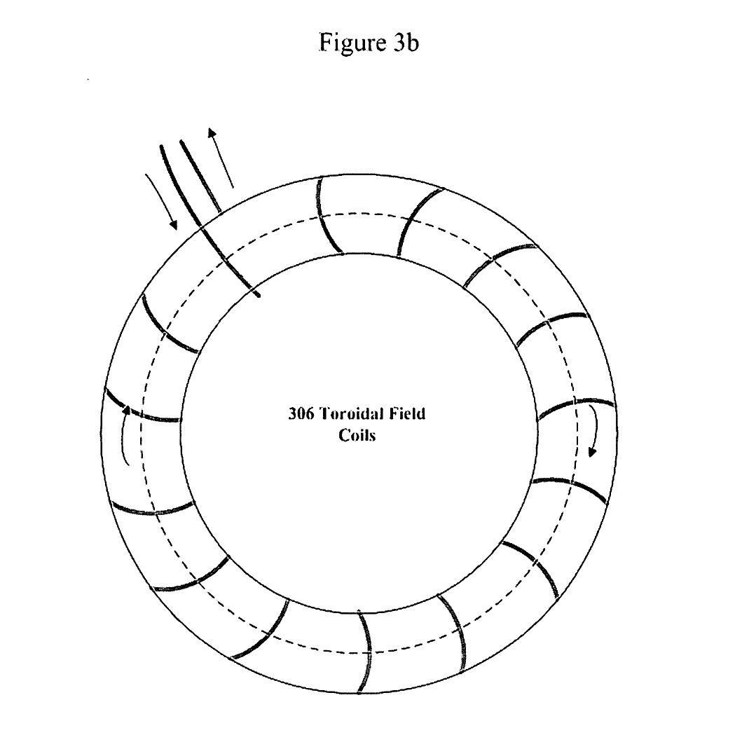

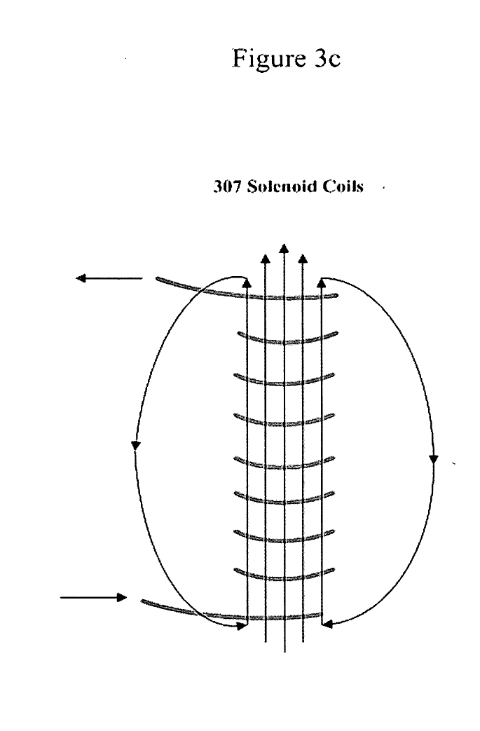

The present invention as shown in FIG. 3 to FIG. 5 is generally implemented based on the fusion reaction of some fusionable gas reacted in very high electrical potential difference generated from a Van De Graaff Generator or Tesla Coils.

Van De Graaff Machine

Invented in the 1930's by the American scientist Robert J. Van De Graaff, the Van De Graaff machine is a machine that can generate very high voltages (millions of volts) used to produce artificial lightning for demonstrations and experiments. Many science museums have large models that can easily generate a few million volts and produce sparks longer than 5 feet. Small desktop models used in classrooms and laboratories can generate 200,000 to 500,000 volts and produce sparks a few inches long.

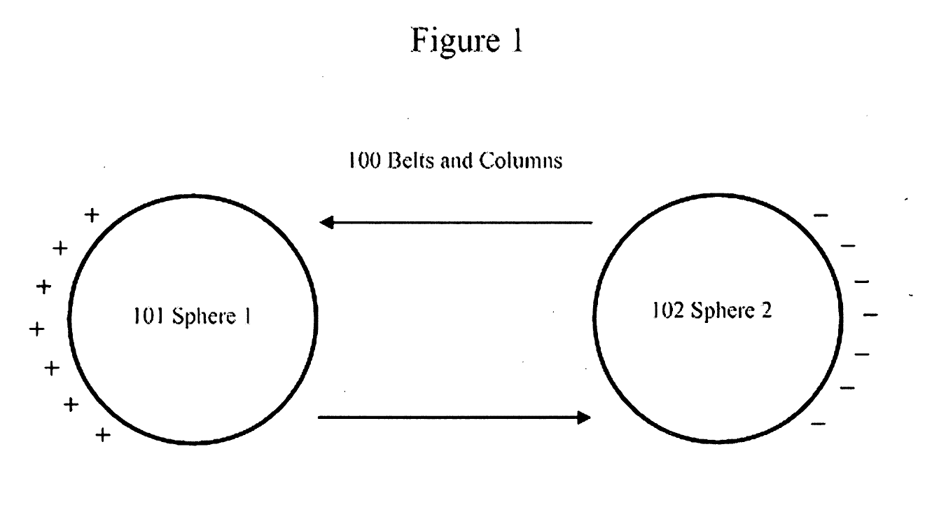

As shown in FIG. 1, the Van De Graaff machine is a fairly simple machine that can be built without a large expense. One of the main components is a moving belt 101 made out of an insulating material such as rubber. Pointed metal needles 102 connected to ground ‘spray’ electric charge onto the lower end of the belt by a process called “corona discharge”. The belt continuously carries the electric charge to the inside of a hollow, metal dome 103, where another set of needles 105 connected to the dome removes the charge with the same corona discharge process. The charge spreads out over the surface of the dome 104 until the voltage is great enough for electrical breakdown of the air to occur, initiating the process of a discharge or spark. This process is very similar to that of a lightning discharge, only on a smaller scale.

The voltage generated from a Van De Graaff machine can be easily calculated. In theory,
1 micro-coulomb: Force*distance=½Q^{ˆ2/C}, or Q=sqrt(2CFd)=1e-7coulombs.

Capacitor voltage is always V=Q/C, and capacitance varies inversely with plate spacing, therefore voltage varies directly with capacitor spacing. Double the spacing, and the voltage will be doubled. In that case, it takes a couple of inches spacing to get 100,000 volts. However, the calculation is far more complicated when the distance is further apart. With Van De Graaff machines, it is proven that a few million or higher voltages can be easily generated.

Like all other electric generators, a Van De Graaff machine is basically a charge pump. It drives negative charge from one end to the other, and/or drives positive charge the other way. The hollow metal ball acts as one output terminal, while its metal base acts as the other. On some VDG machines the upper sphere becomes negatively imbalanced, while the base becomes positive. On other machines the polarity is reversed.

To drive home the idea that a VDG is like a battery or a standard power supply, it helps to imagine the generator like that in FIG. 1.

A VDG machine is a bit like battery. All VDGs actually have a positive terminal 101 and a negative terminal 102 as shown in FIG. 1. However, most models lack the second ball. Instead of a sphere, they have a wire, which connects the base of the generator to ground. Even the grounded-base type of generator actually has two spheres. One is small and metal comparing to the second one in size, which is 8000 miles across. That is, if one end of the generator is connected to ground, then the whole earth becomes the generators second terminal.

Batteries and VDG machines both act as charge pumps. However, a VDG is different from a battery in one important way. Batteries produce constant voltage with variable current, while VDGs produce constant current with variable voltage. A VDG is similar to a battery, but the behavior of its voltage and current are swapped, and everything works backwards. If we short out a battery, we get an electrical overload. When short-circuited, a large current appears in the battery's connecting wires, while the battery voltage remains the same. A VDG is the opposite: to overload a VDG you don't short it out, instead you run it open-circuited with no electrical load attached. When you overload a VDG you get a very large voltage, but the VDG current stays the same. A VDG likes to be shorted, but labors mightily when open-circuited. A battery is opposite: it likes to be open-circuited, but labors mightily when shorted out.

Batteries can produce large currents, while VDG machines can produce large voltages. A car battery is rated at 12 volts, and when a load is connected to it, the battery can create any value of current between zero and 500 amperes or so. A small VDG machine might be rated at 50 microamperes current, and, depending on electrical load, can produce any voltage between zero and 100,000 volts.

VDG machines are also different from common coil/magnet electric generators. A coil-magnet generator pumps charge while it is sweeping a magnetic field across a charge-filled conductor wire. This might seem magical, with invisible magnetic fields causing an electrical pumping action, which creates invisible electric currents. A VDG machine uses a mechanical belt to grab the charge and physically drag the said current along a conductor wire. The electrical difference can be higher than 10 million volts with device as simple as in FIG. 1.

Tesla Coils

The Tesla Coil (TC) was invented in 1891 by Nikola Tesla. It is one of many ingenious devices he created. The AC electrical grid, radio transmitters and car ignition systems we use today are all derived from Tesla's inventions.

A Tesla coil is an air cored oscillation transformer, which produce high voltages but at relatively low currents. All the components in the system are matched so that they oscillate at the same frequency. The end result will be that the voltage input is stepped up by a tremendous amount. This brute force will generate a multi million volt pulse of electricity, which will easily jump 20 feet or longer in the air from one electrode to another, with the distance proportional to the voltage.

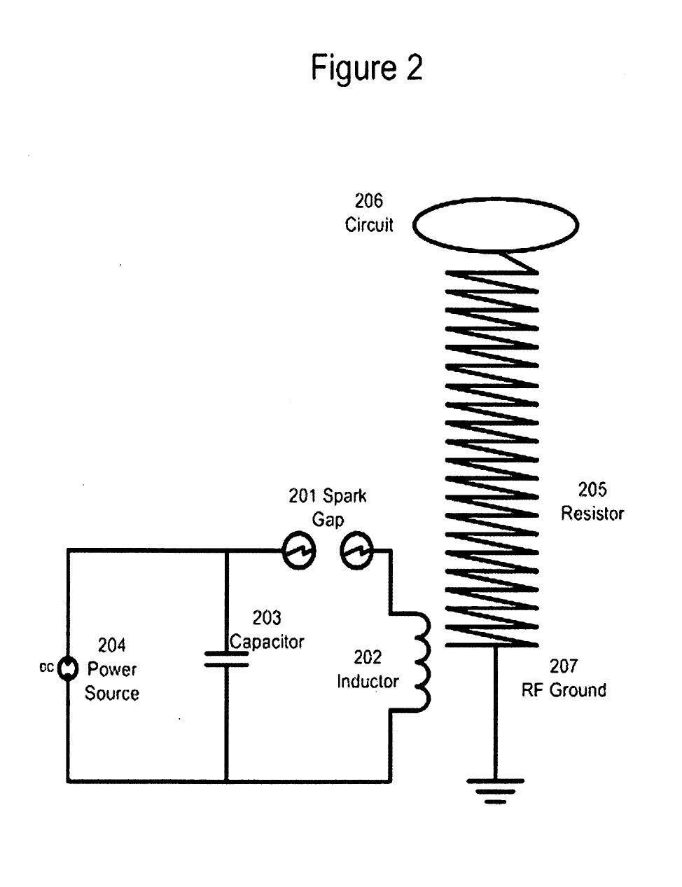

FIG. 2 shows a classical schematic diagram of a Tesla Coil. First of all, the power source 204 is switched on, allowing a current to flow in the primary inductor 202, charging the capacitor 203. When the voltage across the capacitor is high enough, the air in the spark gap 201 breaks down and allows a current to flow. When the switch is dosed, a much higher current flows from the capacitor through the primary inductor. The resulting magnetic field then induces a corresponding current in the secondary circuit 205 and 206.

When the air in the spark gap 201 breaks down, it is acting like a switch connecting the charged capacitor 203 in parallel with the inductor or coil 202. As the initial current flows around the L-C circuit, energy from C1 is stored in a magnetic field created by 202. When the capacitor 203 is discharged, the magnetic field will collapse. This collapsing field will cause a current to flow in the opposite directions as before, therefore recharging the capacitor. This process will then repeat, causing the current to oscillate back and forth until the energy is dissipated by losses in the circuit and the spark gap quenches. This cycle happens within the other cycle described before, i.e. every time the spark gap 201 fires the current will oscillate back and forth between 203 and 202 repeatedly. The frequency at which oscillates is determined by the physical values of the components. This is known as the oscillation frequency. The secondary circuit 205 and 206 must be constructed to create the same oscillation frequency. Since the secondary contains many more turns than the primary, a very high electric field is established in the secondary capacitor.

Fusion Reaction

Together with fusionable materials, the Van De Graaff machine or Tesla Coils could trigger fusion reaction. There is almost always a difference between the masses of the particles, which go into a fusion reaction and the masses of the particles coming out. According to Einstein's famous law relating energy and mass, E=mc², the “mass difference” can take the form of energy. Fusion reactions involving nuclei from hydrogen to nuclei lighter than iron typically release energy. However, fusion reactions involving nuclei heavier than iron typically absorb energy instead.

The energy released from the said fusion reaction is considered “binding energy” of the elements. If the reactants are bound more weakly than the products, then energy is released in the reaction. Binding energy is the amount of energy is put into a system in order to pull its components apart. Conversely, a lot of energy is released as the components are allowed to bond together in a system with high binding energy. The binding energy can be produced in one or combination of the following ways:
D+D→He³ (0.82 MeV)+n (2.45 MeV)
D+D→He⁴+gamma (23.85 MeV)
D+D→T (1.01 MeV)+p (3.02 MeV)
D+T→He⁴ (3.5 MeV)+n (14.1 MeV)
T+T→He⁴+2n+11.3 MeV
D+He³→He⁴ (3.6 MeV)+p (14.7 MeV)
T+He³→He⁴+p+n+12.1 MeV
T+He³→He⁴ (4.8 MeV)+D (9.5 MeV)
T+He³→He⁴ (0.5 MeV)+n (1.9 MeV)+p (11.9 MeV)
p+Li⁶→He⁴ (1.7 MeV)+He³ (2.3 MeV)
n+Li⁶→He⁴ (2.1 MeV)+T (2.7 MeV)
n+Li⁷→He⁴+T+n−some energy
D+Li⁶→2 He⁴+22.4 MeV
p+Li⁷→2 He⁴+17.3 MeV
p+B¹¹→3 He⁴+8.7 MeV

To trigger the release of energy, unlike prior arts, very high electrical difference with low energy input will be applied to the system to cause the fusion reaction. The system is not suitable for continuous fusion reaction. The objectives of the system will be to generate very high-energy output with low energy input. Thus, continuous fusion reaction will not be relevant in the scope of this design.

The devices in embodiments below can be replaced with Tesla Coils, which is capable of generating very high electrical difference like Van De Graaff Machine is with low energy input.

### Embodiment 1—Van De Graaff Machine with Magnet System in Closed Spherical Space

A typical cloud to ground lightning is created within the dome. Some fusionable materials, deuterium and tritium—two isotopes of hydrogen, are used to form a gas mixture. The gas mixture is injected into and contained in a balloon 303, which is produced and released from a balloon ejector 308 on a scheduled basis. The balloon will be fasted to a string and a thin wire. The thin wire will remain on top of the balloon ejector, near the VDG machine 302. The one end of the string will be fasted to the balloon, while the other end will be anchored on a metal ball. The metal ball will be slid down to the bottom of the balloon track 310.

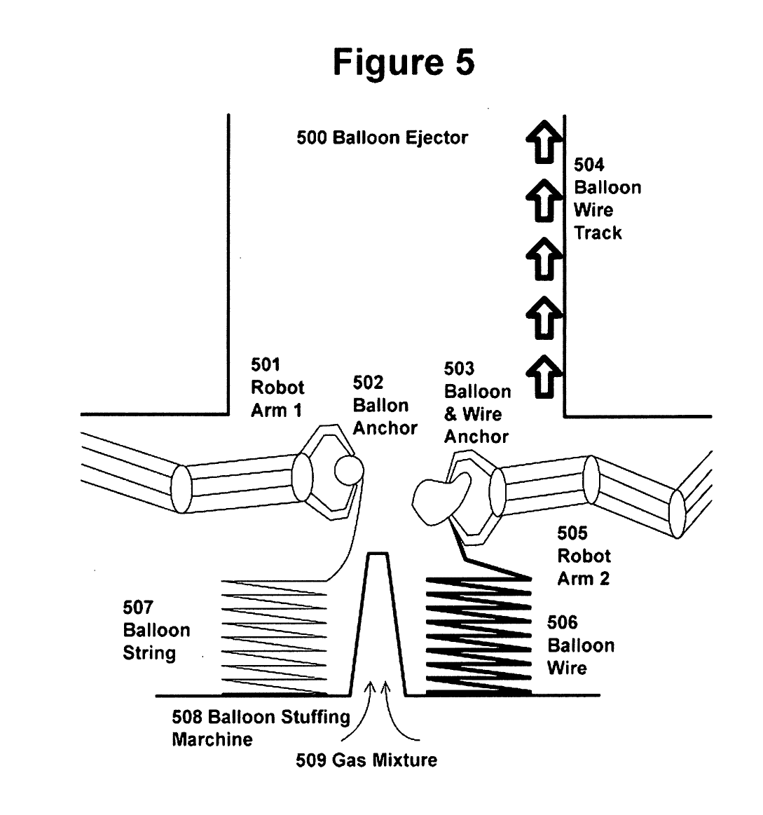

As shown in FIG. 5, the balloon stuffing machine 508 will stuff the fusionable gas mixture 509 into a balloon mounted by robot arm 2 505, which also attaches a wire (from balloon wire 506) on the balloon while robot arm 2 501 will tighten a string (from balloon string 507) to the balloon with a balloon anchor 502. The balloon will then be ejected from the balloon ejector chamber 500, while the balloon wire anchor will be sliding on the balloon wire track 504.

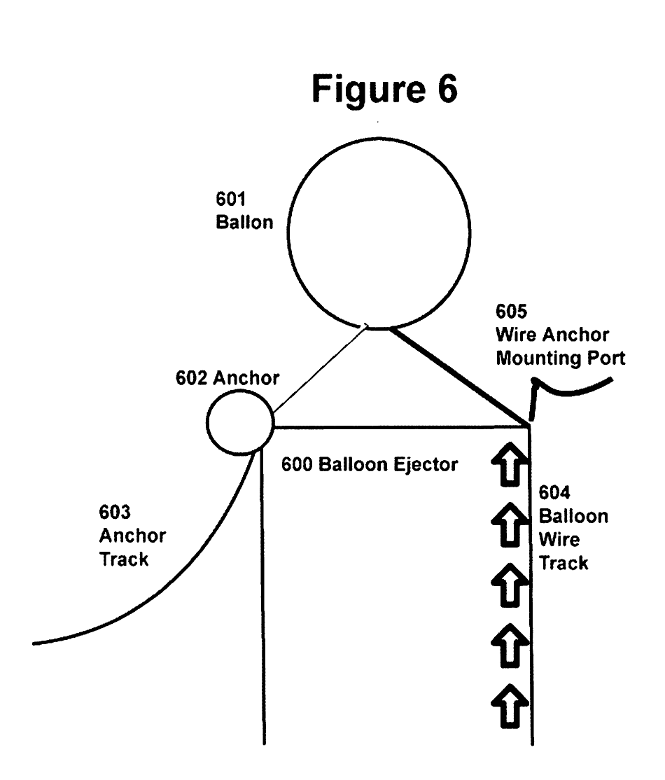

Then as shown in FIG. 6, a balloon 601 will be ejected from the balloon ejector 600. The balloon anchor 602 will slide down to the bottom of the spherical structure, following the anchor track 603. The wire anchor will be held steady by the wire anchor mounting port 605.

The VDG machine 302 will be operated to million volts of negatively charged potential difference. The said negatively charge will be conducted to the fusionable materials 303 contained in the balloon via the thin charge conduction wire 305 attached to the balloon. The lower part of the balloon 303 is negatively charged.

The VDG machine 301 will be operated to million volts of positively charged potential difference. The said positively charge 304 will be conducted to the ground where the lightning conductor 309 is located. The very high potential difference reacts on the fusionable materials to produce fusion, and thus lightning. Lightning from the negatively charged area of the balloon 303 then causes a negative charge to the ground and is called a negative flash. The lightning will generate a current carrying high power. The residue energy and heat emitted from the fusion reaction will be controlled by the magnet system 306 and 307, installed on top of the dome.

A typical lightning flash lasts about a quarter of a second and consists of 3 or 4 individual discharges called strokes. Each stroke lasts a few ten thousandths of a second, although the visual appearance is longer.

A lightning stroke begins with a faint pre-discharge, called the leader, which goes from the cloud mixture contained in the balloon 303 to the ground. The balloon will be completely destructed when the first lightning stroke occurs. The volume of the residue fusionable materials left after the initial fusion reaction will determine the occurrences of the following discharges. Typically, the leader establishes a path for the return stroke, which propagates from the ground up to the cloud of fusionable materials. Once a connecting path is achieved, a return stroke flies up the already ionized path. The tremendous hear causes the air to expand very quickly and forming a shock wave, which eventually turns into thunder. The shock wave can be absorbed with wave transforming device installed in the interior wall of the structure.

The fusionable materials to be used are deuterium and tritium—two isotopes of hydrogen. Deuterium occurs naturally in sea water. Tritium does not occur naturally, but can be bred in a fusion system when the light element, lithium, absorbs neutrons produced in the fusion reaction. World resources of lithium are plentiful.

Wall Conditioning and Pumping

Wall conditioning will be used prior to fusion reaction to remove water, oxygen, and other impurities from the plasma facing walls, to reduce hydrogenic gas recycling from the walls during operations.

A pumping system, used in typical Tokamak reactors, will be used to pump the plasma exhaust consisting primarily of hydrogen isotopes together with helium and impurity gases. It also serves to perform leak testing on the walls.

Magnet System

Superconducting magnets confine and control the reacting plasma and induce an electrical current through it. The magnet system needs not be operated at all time. It is operated only when the fusionable materials are conducted to the center of the building and when lightning reaction occurs.

Said magnet system is a method of containing a plasma or charged particles in a finite region using magnetic fields with charged particles travel in helical paths around the magnetic field lines and this confines their motion to the local vicinity of the magnetic field (one example of a magnetic confinement device is a Tokamak) with internal surrounding wall made with Vanadium Alloy.

The details of wall conditioning, the pump system, and the magnet system are not in the scope of this invention.

### Embodiment 2—Van de Graaff Machine without Magnet System in Very Large Closed Spherical Space

In the nature, where a thunderstorm grows over a tall Earth grounded object, such as a radio antenna, an upward leader may occasionally propagate from the object toward the cloud. This “ground-to-cloud” flash generally transfers a net positive charge to Earth and is characterized by upward pointing branches.

When the potential becomes great enough, electricity punches its way through air that normal insulates and builds a narrow bridge of electrified gas or plasma. The current burrows its way in search of an oppositely charged region where the imbalance can be relieved. When the two are joined, current flows freely and ionizes even more air on its path, thus creating the glowing hydra that we see as a lightning bolt. The heat is radiated from the reaction path on the air. The heated air then expands and, when the discharge is suddenly stopped, it slams back together to produce the thunderclap.

A typical cloud to ground lightning is created within the dome. Some fusionable materials, deuterium and tritium—two isotopes of hydrogen, are used to form a gas mixture. The gas mixture is injected into and contained in a balloon 403, which is produced and released from a balloon ejector 406 on a scheduled basis. The balloon will be fasted to a string and a thin wire. The thin wire will remain on top of the balloon ejector, near the VDG machine 402. The one end of the string will be fasted to the balloon, while the other end will be anchored on a metal ball. The metal ball will be slid down to the bottom of the balloon track 408.

As shown in FIG. 5, the balloon stuffing machine 508 will stuff the fusionable gas mixture 509 into a balloon mounted by robot arm 2 505, which also attaches a wire (from balloon wire 506) on the balloon while robot arm 2 501 will tighten a string (from balloon string 507) to the balloon with a balloon anchor 502. The balloon will then be ejected from the balloon ejector chamber 500, while the balloon wire anchor will be sliding on the balloon wire track 504.

Then as shown in FIG. 6, a balloon 601 will be ejected from the balloon ejector 600. The balloon anchor 602 will slide down to the bottom of the spherical structure, following the anchor track 603. The wire anchor will be held steady by the wire anchor mounting port 605.

The VDG machine 402 will be operated to million volts of negatively charged potential difference. The said negatively charge will be conducted to the fusionable materials 403 contained in the balloon via the thin charge conduction wire 405 attached to the balloon. The lower part of the balloon 403 is negatively charged.

The VDG machine 401 will be operated to million volts of positively charged potential difference. The said positively charge 404 will be conducted to the ground where the lightning conductor 407 is located. The very high potential difference reacts on the fusionable materials to produce fusion, and thus lightning. Lightning from the negatively charged area of the balloon 403 then causes a negative charge to the ground and is called a negative flash. The lightning will generate a current carrying high power.

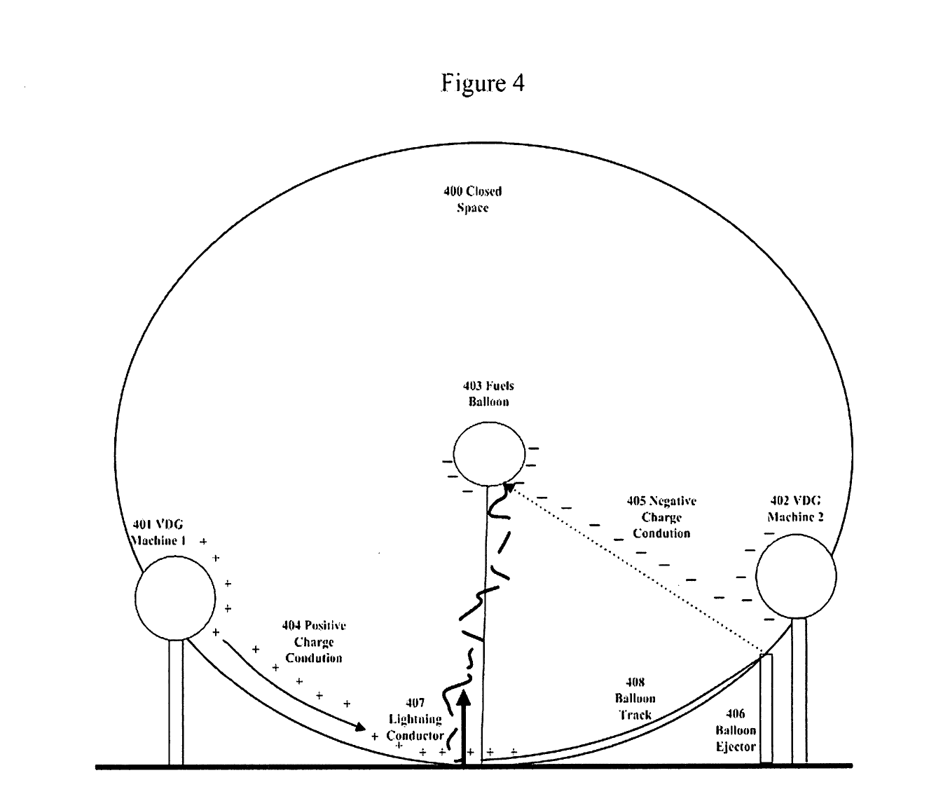

As shown in FIG. 4, since the heat radiated from the fusion reaction can be over 30,000 degree Kelvin, a dome like (hemispherical) power plant has induced the D+T gas mixture with volume of 831 to 1500 m³with surrounding vacuum volume of at 30 to 1. Hence, according to the formula
Volume of sphere=4/3 πr³

A spherical structure of 100 meters in diameter will have an above 250 to 1 volume ratio which is sufficient to contain the heat radiated with internal surrounding wall made with Vanadium Alloy which sustain heat over 650 degree K. The diameter of the said structure is recommended to have at least 100 meters in diameter, or in a very large spherical dome such that the space will be sufficient to contain the heat radiated. The internal wall surface area of the structure will absorb the heat evenly.
Surface area of sphere=4 πr²

Wall Conditioning and Pumping

Wall conditioning will be used prior to fusion reaction to remove water, oxygen, and other impurities from the plasma facing walls, to reduce hydrogenic gas recycling from the walls during operations.

A pumping system, used in typical Tokamak reactors, will be used to pump the plasma exhaust consisting primarily of hydrogen isotopes together with helium and impurity gases. It also serves to perform leak testing on the walls.

The details of wall conditioning, and the pump system are not in the scope of this invention.

What is claimed is:

1. A system generates very high electrical potential difference is comprised of:
a) a spherical dome structure with walls made from vanadium alloys to withstand high thermal condition, high mechanical stress and intense neutron bombardment
b) a system capable of generating very high electrical voltage from Van De Graaff machine;
c) a chamber emitting fusionable materials such as deuterium;
d) a balloon ejector taking in the fusionable materials from the chamber, and blowing into a balloon; the balloon is then ejected to a dome structure;
e) a conducting device conducting electricity generated;
f) a vacuuming system controlling residue fusionable materials and the compounds generated from the fusion reaction;

2. A system according to claim 1, is further comprised of a magnetic system capable of controlling the said fusion reaction

3. A system according to claim 1, wherein said system shall have reaction with fusionable materials deuterium which will react to produce helium or tritium to release binding energy:
D+D→He³ (0.82 MeV)+n (2.45 MeV),
D+D→He⁴+gamma (23.85 MeV).
D+D→T (1.01 MeV)+p (3.02 MeV).

4. A system according to claim 1, wherein said system shall have reaction with fusionable materials mixed with deuterium and tritium which will react to produce helium to release binding energy:
D+T→He⁴ (3.5 MeV)+n (14.1 MeV)

5. A system according to claim 1, wherein said system shall have reaction with fusionable materials tritium which will react to produce helium to release binding energy:
T+T→He⁴+2n+11.3 MeV

6. A system according to claim 1, wherein said system shall have reaction with fusionable materials mixed deuterium or tritium with helium which will react to produce helium to release binding energy:
D+He³→He⁴ (3.6 MeV)+p (14.7 MeV)
T+He³→He⁴+p+n+12.1 MeV
T+He³→He⁴ (4.8 MeV)+D (9.5 MeV)
T+He³→He⁴ (0.5 MeV)+n (1.9 MeV)+p (11.9 MeV)

7. A system according to claim 1, wherein said system shall have reaction with fusionable materials lithium which will react to produce helium and tritium to release binding energy:
p+Li⁶→He⁴ (1.7 MeV)+He³ (2.3 MeV)
n+Li⁶→He⁴ (2.1 MeV)+T (2.7 MeV)
n+Li⁷→He⁴+T+n−some energy
p+Li₇→2 He⁴+17.3 MeV

8. A system according to claim 1, wherein said system shall have reaction with fusionable materials mixed with deuterium and lithium which will react to produce helium to release binding energy:
D+L⁶→2 He⁴+22.4 MeV

9. A system according to claim 1, wherein said system shall have reaction with fusionable materials boron which will react to produce helium to release binding energy:
p+B¹¹→3 He⁴+8.7 MeV

10. A system according to claim 1, wherein said fusionable materials is mixed from a source of gaseous catalyst, selected from the group consisting of beryllium, carbonates, hydroxides, halides, sulfates, phosphates, and sulfides.

11. A system according to claim 2, wherein said system shall have reaction with fusionable materials deuterium which will react to produce helium or tritium to release binding energy:
D+D→He³ (0.82 MeV)+n (2.45 MeV),
D+D→He⁴+gamma (23.85 MeV).
D+D→T (1.01 MeV)+p (3.02 MeV).

12. A system according to claim 2, wherein said system shall have reaction with fusionable materials mixed with deuterium and tritium which will react to produce helium to release binding energy:
D+T→He⁴ (3.5 MeV)+n (14.1 MeV)

13. A system according to claim 2, wherein said system shall have reaction with fusionable materials tritium which will react to produce helium to release binding energy:
T+T→He⁴+2n+11.3 MeV

14. A system according to claim 2, wherein said system shall have reaction with fusionable materials mixed deuterium or tritium with helium which will react to produce helium to release binding energy:
D+He³→He⁴ (3.6 MeV)+p (14.7 MeV)
T+He³→He⁴+p+n+12.1 MeV
T+He³→He⁴ (4.8 MeV)+D (9.5 MeV)
T+He³→He⁴ (0.5 MeV)+n (1.9 MeV)+p (11.9 MeV)

15. A system according to claim 2, wherein said system shall have reaction with fusionable materials lithium which will react to produce helium and tritium to release binding energy:
p+Li⁶→He⁴ (1.7 MeV)+He³ (2.3 MeV)
n+Li⁶→He⁴ (2.1 MeV)+T (2.7 MeV)
n+Li⁷→He⁴+T+n−some energy
p+Li₇→2 He⁴+17.3 MeV

16. A system according to claim 2, wherein said system shall have reaction with fusionable materials mixed with deuterium and lithium which will react to produce helium to release binding energy:
D+Li⁶→2 He⁴+22.4 MeV

17. A system according to claim 2, wherein said system shall have reaction with fusionable materials boron which will react to produce helium to release binding energy:
p+B¹¹→3 He⁴+8.7 MeV

18. A system according to claim 2, wherein said fusionable materials is mixed from a source of gaseous catalyst, selected from the group consisting of beryllium, carbonates, hydroxides, halides, sulfates, phosphates, and sulfides.

19. A system according to claim 1, is comprised of a system capable of generating very high electrical voltage from Tesla Coils devices instead of Van De Graaff machine, wherein said system shall have reaction with fusionable materials which will react according to claims 3 to 18 to release binding energy.
